(19) United States
(12) Patent Application Publication
(10) Pub. No.: US 2026/0065103 A1
(43) Pub. Date: Mar. 5, 2026

(54) LEVERAGING LARGE LANGUAGE MODELS TO CRAFT MEANINGFUL SYNTHESIS OF THE UNDERLYING TRENDS AND PATTERNS IN A CERTAIN SEGMENTS

(71) Applicant: Oracle International Corporation, Redwood Shores, CA (US)

(72) Inventors: Manish Daga, Karnataka (IN); Muthu Ranganathan, Karnataka (IN); Selvarajan Kandasamy, Karnataka (IN); Shivaranjan Gurunanjappa, Karnataka (IN); Nitin Rawat, Karnataka (IN)

(73) Assignee: Oracle International Corporation, Redwood Shores, CA (US)

(21) Appl. No.: 19/170,266

(22) Filed: Apr. 4, 2025

Related U.S. Application Data
(60) Provisional application No. 63/691,236, filed on Sep. 5, 2024.

(51) Int. Cl. G06N 5/045; G06F 16/3329; G06N 5/043

(52) U.S. Cl. CPC G06N 5/045; G06F 16/33295; G06N 5/043

(57) ABSTRACT

Systems, articles, and computer-implemented methods are provided for generating summaries of a plurality of insights in multi-dimensional data to describe underlying trends using a large language model. A data structure is generated describing the plurality of insights where the data structure encapsulates for each insight of the plurality of insights to be included: a member of a data hierarchy that fits a descendant dimension that includes the insight, a value of the descendant dimension that fits the insight, and a characteristic of the insight. The data structure is included within a prompt to a large language model to summarize the plurality of insights. The prompt may also include data representing a relationship between the plurality of insights, such as how a first insight of the plurality of insights contributes to a second insight of the plurality of insights.

### CROSS-REFERENCE TO RELATED APPLICATION(S)

This application claims the benefit of U.S. Provisional Patent Application No. 63/691,236, filed Sep. 5, 2024. The entire disclosure of the aforementioned application is incorporated by reference herein in its entirety for all purposes.

### BACKGROUND

Multi-dimensional data records vast amounts of data with many inter-connected relationships between the data. The interconnections between the data allow for a great deal of insight. However, the complexities that allow for deep insight also expose the possibility for significant mischaracterizations of the data.

### BRIEF SUMMARY

In some embodiments, systems, articles, and computer-implemented methods are provided for generating summaries of a plurality of insights in multi-dimensional data to describe underlying trends using a large language model. A data structure is generated describing the plurality of insights where the data structure encapsulates for each insight of the plurality of insights to be included: a member of a data hierarchy that fits a descendant dimension that includes the insight, a value of the descendant dimension that fits the insight, and a characteristic of the insight. The data structure is included within a prompt to a large language model to summarize the plurality of insights. The prompt may also include data representing a relationship between the plurality of insights, such as how a first insight of the plurality of insights contributes to a second insight of the plurality of insights.

In a particular embodiment, a computer-implemented method includes accessing a hierarchy of multi-dimensional data, the hierarchy including one or more ancestor nodes and two or more descendant dimension nodes. The computer-implemented method also includes iterating over nodes in the hierarchy as base nodes to detect anomalies or patterns for the base nodes, the iterating includes detecting a first anomaly or pattern for a first descendant dimension of a selected base node and detecting a second anomaly or pattern for a second descendant dimension of the selected base node. The computer-implemented method also includes generating a data structure that encapsulates a first identity of a member of the first descendant dimension that fits the first anomaly or pattern, one or more values of the first descendant dimension that fit the first anomaly or pattern, one or more characteristics of the first anomaly or pattern, a second identity of a member of the second descendant dimension that fits the second anomaly or pattern, one or more values of the second descendant dimension that fit the second anomaly or pattern, and one or more characteristics of the second anomaly or pattern. The computer-implemented method also includes generating a prompt including the data structure and a request to summarize the data structure, prompting a large language model with the prompt to generate a resulting summary of a plurality of patterns or anomalies, and causing display of at least part of the resulting summary of the plurality of patterns or anomalies.

In a further embodiment, the second descendant dimension is also a descendant of the first descendant dimension.

In the same or a different further embodiment, the prompt further includes data representing a relationship between the first anomaly or pattern and the second anomaly or pattern.

In another embodiment that extends the particular embodiment or any further embodiment, the data representing a relationship between the first anomaly or pattern and the second anomaly or pattern is a representation of the contribution of the second anomaly or pattern to the first anomaly or pattern.

In another embodiment that extends the particular embodiment or any further embodiment, iterating over nodes in the hierarchy further includes detecting the first descendant dimension to be a parent dimension to the second descendant dimension and iterating over child nodes of the first descendant dimension, and the detecting the second anomaly or pattern is in response to iterating over child nodes of the first descendant dimension.

In another embodiment that extends the particular embodiment or any further embodiment, detecting the first descendant dimension to be a parent dimension is performed by a first artificial intelligence agent and iterating over child nodes of the first descendant dimension is performed by a second artificial intelligence agent.

In another embodiment that extends the particular embodiment or any further embodiment, iterating over nodes in the hierarchy is performed by a first artificial intelligence agent and the generating a prompt is performed by a second artificial intelligence agent.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for using large language models to analyze underlying trends and patterns in multi-dimensional data.

FIG. 2 illustrates a system diagram showing an example cloud infrastructure for using large language models to analyze underlying trends and patterns in multi-dimensional data.

FIG. 3 illustrates a diagram of an example user interface for receiving user requests and displaying synthesized insights to multi-dimensional data.

FIG. 4 illustrates a diagram of an example user interface for displaying generated summaries of patterns or anomalies for management by a user.

FIG. 5 illustrates a diagram of an example user interface for displaying generated summaries of patterns or anomalies with graphical representations of the patterns or anomalies and a more detailed summary of the pattern or anomaly.

FIG. 6 illustrates another diagram of an example user interface for displaying generated summaries of patterns or anomalies with graphical representations of the patterns or anomalies and details of the pattern or anomaly.

FIG. 7 illustrates a diagram of an example user interface for managing the detection and analysis of patterns or anomalies for multi-dimensional data.

FIG. 8 illustrates a diagram of an example user interface for receiving user requests for synthesizing insights to multi-dimensional data.

FIG. 9 illustrates a diagram of an example user interface for displaying synthesized insights to multi-dimensional data.

FIG. 10 depicts a simplified diagram of a distributed system for implementing certain aspects.

FIG. 11 is a simplified block diagram of one or more components of a system environment by which services provided by one or more components of an embodiment system may be offered as cloud services, in accordance with certain aspects.

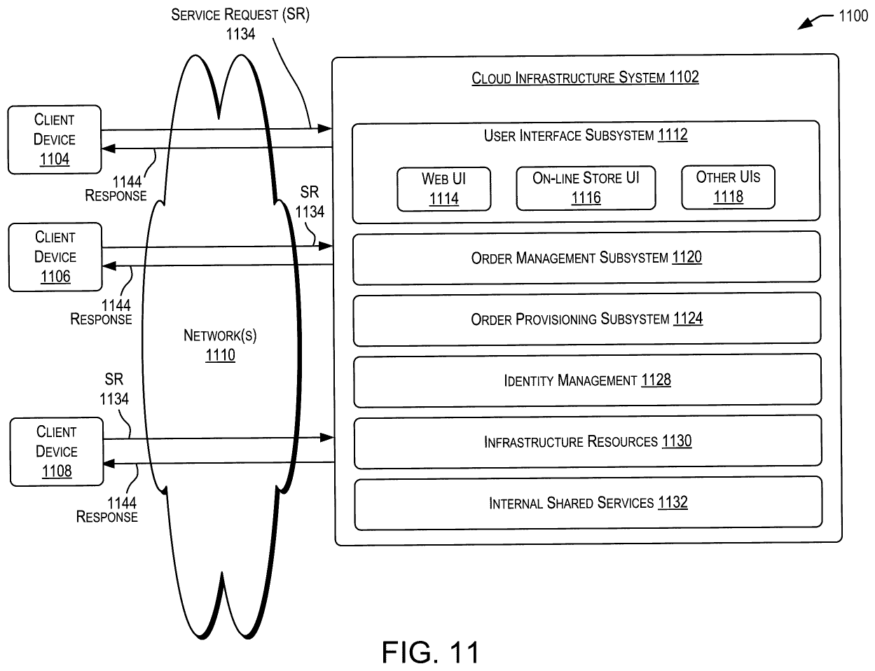

FIG. 12 illustrates an example computer system that may be used to implement certain aspects.

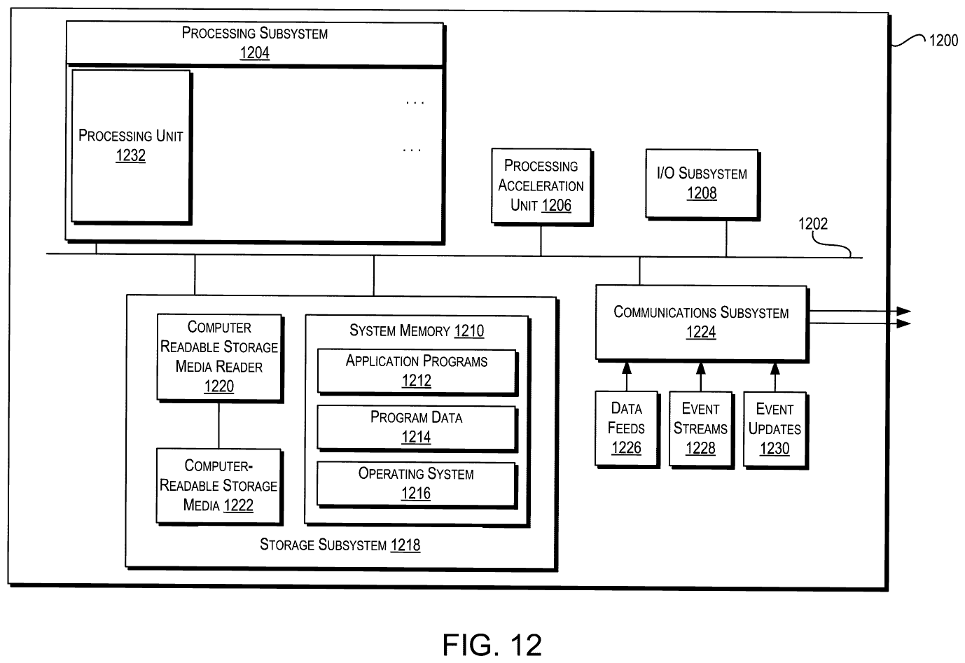

### DETAILED DESCRIPTION

A description is provided for using large language models to analyze underlying trends and patterns in multi-dimensional data. In various embodiments, the analysis of multi-dimensional data is implemented using non-transitory computer-readable storage media to store instructions which, when executed by one or more processors of a computer system, cause display of the user interface and processing of the received input to analyze multi-dimensional data. The analysis of multi-dimensional data may be implemented on a local or cloud-based computer system that includes processors and a display for showing the user interface to a user for analyzing multi-dimensional data. The computer system may communicate with client computer systems for analysis of multi-dimensional data.

A description of analysis of multi-dimensional data is provided in the following sections:
INSIGHTS FOR MULTI-DIMENSIONAL DATA
DETERMINATION OF RELEVENT INSIGHTS
PROMPT GENERATION.
EXECUTION OF PROMPT AND DISPLAY OF SUMMARY.
RE-PROMPTING THE LARGE LANGUAGE MODEL
MULTI-DIMENSIONAL ANALYSIS BY ARTIFICIAL INTELLIGENCE AGENTS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Insights for Multi-Dimensional Data

Multi-dimensional analysis concerns the analysis of data within a dataset containing a plurality of data dimensions. By selecting values for a set of dimensions, a data view may be constructed comprising the data records containing the selected values for the set of dimensions. The data view represents a union of all the records of the selected set of dimension values. Data analysis between further values of the records of other dimensions may be performed on the data view to create analytical results, or insights, specific to the selected values of the set of dimensions.

Such insights may include identification of anomalous values within the data views, comparing the values of two dimensions across the data view such as to compare a prediction to recorded real values or other prediction values of another source or method. Multi-dimensional analysis allows for insights into the data that are more detailed than analysis across whole data sets.

Hierarchical data may be stored as a cube or a collection of dimensions, where each dimension has members arranged in a hierarchy. A “dimension” is a collection of related data items that are organized together and, for example, may share a common data structure, schema subset, or index, and may be related to other dimensions. Dimensions may have one or more attributes or fields that define values, or that define formulas for obtaining values. Non-limiting examples of dimensions may include account, department, business unit, product line, market, division, time, and location, and each dimension may have multiple levels of members or nodes with information. As used herein, the terms “member,” “node,” and “row” are used interchangeably to refer to an individual item of data hierarchically positioned in a structured dataset. Each member may be a child of another member or a root member for the dimension, forming a tree of members for each dimension that can be represented as a drill-down hierarchy of members along each dimension.

Data may be maintained at the lowest levels of the tree structure and rolled up to higher levels. For example, data on the monthly level of time data of January, February, and March may be rolled up to data on the quarterly level of time data, which may be rolled up to data on the annual level of time data. Similarly, data at the city level of a location dimension may be rolled up to data on the state level of the location dimension, which may be rolled up to data at the country level. Other dimensions, such as product information, sales information, and other information, may be linked to the time dimension such that slices of data may be obtained as intersections between the corresponding values for the corresponding dimensions. Dimensions may be linked together using keys or other references that identify specific members of other dimensions associated with a record. Additional details may be pulled from the other dimensions using the key as a reference to the other dimension and drilling down or rolling up in the data structure along the other dimension. For example, information about a particular product having units sold in a given quarter may be determined from an intersection between the product, sales, and time dimensions as a data slice.

A schema or hierarchical structure may be applied to the members, and different dimensions may support different sub-schemas of the database where data fitting within the dimension conforms to a certain data format and has certain well-defined relationships with other data in the dimension. Data fitting within certain parts of the schema or hierarchical structure may feed into or be bound to formulas, workflows, models or other logic managed by an application to use the data to efficiently determine values or accomplish tasks. For example, the weight of all units in a “units produced” portion of the hierarchy may be used in a first formula for determining individual shipping costs for each unit and a second formula for aggregating shipping costs across all units.

In one embodiment, a multidimensional data management application provides access to data for analysis and management. Dimensions that align with existing structures, relationships, and logic in a stored hierarchy of data may have pre-configured structure, relationships, and logical formulas, models, or workflows that use the values provided or statically defined to populate other dynamic nodes that depend on the static values. Uploaded data may fit into a structure expected by existing logic such that the existing logic is automatically updated as the uploaded data is provided. For example, if a dynamic node exists where all children nodes are summed together, and the uploaded data adds or updates a child node of the dynamic node, the dynamic node may be updated automatically to account for the uploaded data.

In one embodiment, a data management application such as Oracle Essbase® provides views of multidimensional data, and the views provide options for modifying or analyzing the multidimensional data according to a data management user interface. In one example, the views are displayed in a Microsoft Excel interface using a Microsoft Excel plug-in to control what data is visible in which cells, whether that data is modifiable, and what database structures of a back-end database are mapped to the cell such that the corresponding cell holds value(s) of the database structures and the database structures get modified when the corresponding cell gets modified.

In another example, the views are displayed in a browser interface that shows a grid of cells where code executed in the browser controls what data is visible in which cells, whether the data is modifiable, and what database structures of a back-end database are mapped to the cell such that the corresponding cell holds value(s) of the database structures and the database structures get modified when the corresponding cell gets modified.

A particular combination of values across different dimensions is shown on the screen as one or more data slices, and the data slice(s) may be filtered or combined with other data slice(s) to change a shape of the dataset being visualized, modified, or analyzed.

In constructing a data view, one or more dimensions are selected to be used to define the data view of a database structure. The dimensions may describe levels of hierarchy in the case of hierarchical data. In this case, selecting a specific point in the hierarchy includes within the data view all data descendent from that specific point in the hierarchy and excludes all other data that is not descendent from that specific point in the hierarchy. For example, a hierarchical data structure may store data for multiple regions an organization operates in with multiple constituent entities of the organization, each with their own set of staff. The data is stored hierarchically such that a first dimension defines the region for a data record, a second dimension defines an entity, where each entity is associated with a specific region and therefore descendent from that region, and each record represents a staff member with each record having am entity and region dimension and therefore descending from their entity and region. In attempting to perform data analysis on the staff of a specific region, the value of the specific region is selected for the region dimension which creates a data view including all descendent entities and descendent staff for that region and excluding those records of other regions. Data views may be selected based on multiple dimensions, such as a data view selecting for a region, entity, product, and account dimensions. The resulting data view is a union of all the records of the selected region, selected entity, selected product, and selected account dimensions.

Before performing analysis on a data view, the data insight system may determine if analysis is enabled for the dimensions selected. The dimensions may be enabled for analysis by inclusion within a data view or by data access controls. Data access controls may be implemented on a dimension-by-dimension basis such that a user's access credentials are checked against each dimension included for analysis to determine if analysis is enabled for that dimension. Dimensions may be determined to be enabled for analysis based on inclusion within a data view. By selecting a dimension or a predefined data view, the resulting constructed data view of extracted data of those dimensions are said to be enabled while data of other dimensions are said to be disabled.

After a data view is constructed, any number of analyses may be performed on that data view. Multi-dimensional data analysis may include anomaly detection among the records of the data view for a specific dimension of the data view. First, the data of the data view is extracted, including at least the data of an input dimension that is varied across records, such as time, to determine anomalies in an output dimension, such as an expense value. For all analyses determining a notable result, that result is stored as an insight to the data in association with the dimensions for the result of the analysis.

Analysis may be performed in any number of circumstances and in response to multiple conditions. For example, analysis may be performed periodically, where a device storing data tracks a time period for analysis and performs the analysis at a regular time interval. Alternatively, analysis may be performed in response to the addition of more data to the data set.

Anomaly detection analysis may be performed by determining a deviation of the value of a selected record from the mean across the records of a data view for a given dimension and comparing that deviation to a threshold. The given dimension across which to perform the anomaly detection may be a time dimension. In this case, the required data of the analyzed dimensions are extracted and stored as a time series across which the anomaly analysis is performed.

The deviation may be determined as a normalized value such as a standard deviation which is compared to a threshold of standard deviations. For example, the normalized difference between the detected value and the mean may be beyond three standard deviations from the mean, with three standard deviations being the threshold value, therefore the detected value is marked as an anomaly and values describing the anomaly are stored.

Alternatively, anomaly detection may be performed using a modified Z score, or a standardized score measured against the median of a set of data. The anomaly may be detected by an absolute deviation from a median being beyond a given threshold value.

Alternatively, anomaly detection may be performed using an interquartile range, midspread, fourth spread, or H-spread. In this case, the anomaly is detected by first dividing the data set into quartiles via linear interpolation, then determining the anomalous value to be greater than an upper or lower quartile value by a given value, such as a percentage of the width between the mean value and the upper or lower quartile value.

Alternatively, anomaly detection may be performed by determining a deviation from a dynamically constructed range from the values of the data view. In this case, a metric is used to determine clusters of values based on an average variance. Anomalous values are values that do not fit within a threshold difference from an average variance of any cluster of data.

In response to detecting the anomaly, data values representing the anomaly or calculated in response to the anomaly are stored. For example, the data insight system may store the anomalous value, the mean value from which the anomalous value differs, and the calculated difference between the anomalous value and the mean. The data insight system may also, in response to detecting the anomaly, calculate a percentage difference representing the percentage of the mean by which the anomalous value differs or a frequency of the anomaly. The data insight system may also determine and store a number of previous anomalous value, a previous most anomalous data value, and the period for that previous most anomalous value.

In response to detecting the anomaly, an anomaly direction may be stored. The anomaly direction may indicate whether the anomaly value differs from a mean or threshold above the mean or threshold or below the mean or threshold. The data insight system may determine whether to label the anomaly as positive or negative based on the dimension's inherent qualities. For example, a revenue dimension may have a normal mapping such that a value above the mean is labeled as a positive anomaly and a value below the mean is a negative anomaly. In contrast, an expense dimension may have an inverted mapping such that values above the mean are labeled as a negative anomaly and a value below the mean is a positive anomaly.

Forecast variance bias analysis may be performed by determining a deviation of the value of a selected record from the forecasted value for the selected record for a given dimension and comparing that deviation to a threshold. The given dimension across which to perform the anomaly detection may be a time dimension. In this case, the required data of the analyzed dimensions are extracted and stored as a time series across which the forecast variance bias analysis is performed.

The forecasted value may be an estimated value for a future time generated previously based on past data. For example, the forecasted value may be a value determined from a fit trend line of a set of previous values.

Prediction analysis may be performed by determining a deviation of the prediction value of a selected record from the forecasted value for the selected record for a given dimension and comparing that deviation to a threshold. The given dimension across which to perform the anomaly detection may be a time dimension. In this case, the required data of the analyzed dimensions are extracted and stored as a time series across which the prediction analysis is performed.

The predicted value may be a value generated by a machine learning model for predicting values. Therefore, a difference between the predicted value and the forecasted value for a record represents the difference between a simple mathematical forecast and a prediction generated based on a machine learning model trained on similar data.

### Determination of Relevant Insights

Relevant dimensions are identified that are to be included in a summary or analysis of data patterns. Some dimensions contribute less useful data towards generating insights, therefore, to reduce the amount of work performed by a large language model, reduce the amount of tokens used in a prompt to a large language model, and reduce the chance for hallucinations by the large language model, the number of dimensions utilized in generating summaries may be reduced or limited to a selected set of dimensions.

Dimensions may be excluded from selection based on usage for data aggregation. A dimension's usage for data aggregation is dependent upon whether the dimension is higher in a hierarchy and thus aggregates for a greater number of nodes, and the extent to which selecting for the dimension alters the data view selected. For example, a “version” dimension which describes a version of a product or item it describes is not often used to aggregate records as it is low in the hierarchy of dimensions. That is, when selecting a data view, a “version” dimension is an uncommon dimension for selecting to limit the data view by and when selecting for the “version” dimension, there is expected to be little impact on the scope of the data view as the “version” dimension is low in the hierarchy. In contrast, a “region” dimension is highly aggregating as it is likely high in the hierarchy of dimensions and would likely include many nodes for each value of the “region” dimension, therefore selecting for the “region” dimension greatly alters the scope of the data view. In Table 1 below, a sample dimension ancestry is shown which indicates the “Product” and “Region” dimensions to be aggregating dimensions due to the depth of hierarchy beneath them.

TABLE 1

| | | | | Customer |
|---|---|---|---|---|
| Account | Product | Entity | Channel | Group |
| Revenue | Personal Care | US | Retail Store | Key Accounts |
| | --Bath Soap | --US - East | Mobile | High Net Worth |
| | ----Bath Soap Brand 1 | --US - West | Online | B2B |
| | ----Bath Soap Brand 2 | ----California | | |
| | --Beauty Soap | ----Washington | | |
| | ----Beauty Soap Brand 1 | --US - Northeast | | |
| | ----Beauty Soap Brand 2 | ----New York | | |
| | ----Beauty Soap Brand 3 | ----Massachusetts | | |
| | --Baby Soap | --US - South | | |
| | --Shampoo | --US - Central | | |
| | --Premium Soap | International | | |
| | --Talcum Powder | --Canada | | |
| | Home Care | --Europe | | |
| | --Washing Powder | ----UK | | |
| | --Detergent Bar | ----Germany | | |
| | --Kitchen Cleaner | ----France | | |
| | --Budget Cleaning | ----Others | | |
| | Powder | | | |
| | Food & Beverages | --Asia Pacific | | |
| | --Premium Tea | ----India | | |
| | --Fruit Jam | ----China | | |
| | --Coffee Powder | | | |
| | --Ice Cream | | | |

From the selected aggregating dimensions, a number of data views are selected based on possible iterations of data views across the aggregating dimensions. For each data view assembled from the aggregating dimensions, the data may be analyzed to determine if an insight exists for that data view. Alternatively, to save time a stored list of previously detected insights may be searched to match a data view to a previously detected insight such that a list of detected insights may be stored from all matching data views of aggregating dimensions.

Table 2 depicts a table of data views, including the dimensions of Table 1, where an insight has been detected.

TABLE 2

| Account | Product | Customer Group | Channel | Entity |
|---|---|---|---|---|
| Revenue | Personal Care | B2B | Online | International |
| Revenue | Personal Care | B2B | Online | --Asia Pacific |
| Revenue | Personal Care | B2B | Online | ----China |
| Revenue | --Bath Soap | B2B | Online | --Asia Pacific |
| Revenue | ----Bath Soap Brand 1 | B2B | Online | --Asia Pacific |
| Revenue | ----Bath Soap Brand 1 | B2B | Online | ----China |
| Revenue | --Beauty Soap | Key Accounts | Mobile | --Europe |
| Revenue | ----Beauty Soap Brand 1 | Key Accounts | Mobile | ----UK |
| Revenue | ----Beauty Soap Brand 2 | Key Accounts | Mobile | ----Germany |
| Revenue | --Baby Soap | B2B | Online | International |
| Revenue | --Baby Soap | Key Accounts | Online | --Asia Pacific |
| Revenue | --Shampoo | B2B | Online | --Europe |
| Revenue | --Shampoo | Key Accounts | Retail Store | --Asia Pacific |
| Revenue | --Premium Soap | High Net Worth | Retail Store | --Canada |
| Revenue | --Premium Soap | High Net Worth | Retail Store | --Asia Pacific |
| Revenue | --Talcum Powder | High Net Worth | Mobile | --Asia Pacific |
| Revenue | --Talcum Powder | B2B | Online | --Asia Pacific |
| Revenue | --Talcum Powder | Key Accounts | Online | --Asia Pacific |
| Revenue | --Talcum Powder | Key Accounts | Mobile | --Asia Pacific |

For generating a summary of insights, a list of relevant insights for the summary from this list of detected insights may be selected, as not all detected insights may relate to the specific values for the selected dimensions the user is interested in. The list of relevant insights may be generated by first selecting an identified aggregating dimension as an anchor dimension and fixing the dimension by selecting a specific value for the dimension specified such as in the user request for the summary. A search loop is performed across the other aggregating dimension members of the data view to determine if an insight exists for a given combination of aggregating dimension values given the fixed anchor value. If an insight is detected, it is recorded as a relevant insight.

The list of relevant insights may also record further relationships between insights by recording the parentage relationship between detected insights. The search loop may be performed first over parent values of a non-anchor aggregating dimension. For all parent values of a non-anchor aggregating dimension where an insight is detected, another search sub-loop may be performed through the child values of the parent value for the non-anchor aggregating dimension. The detected insight of the parent value may be recorded with the aggregating dimension values as a parent insight and any detected insights in the sub-loop of the child values may be recorded as child insights of the parent insight with their respective aggregating dimension values. This looping process is repeated until all child values have been searched for a given parent value for which there was an insight.

After looping across all other non-anchor aggregating dimension values, the same process may be performed for another value of the same anchor dimension that is specified or a new anchor dimension may be defined to loop over for another aggregating dimension value. The net result of the entire looping search process is a list of all relevant insights for the identified dimension values with parentage relationships between the insights recorded. For each child-parent insight pairing, the child insight contributes to the specific insight of the parent value, therefore further analysis may be performed on the relationship between the parent and child insight and the contribution of the child insight to the parent insight.

As an example, to generate a summary for a request to summarize insights on Revenue for Personal Care products of an International entity with an Online channel and a B2B customer group, the process may identify “products” and “entity” as aggregating values, which are used as anchor values for the “Personal Care” value of products and the “International” value of entity. The search loop over the non-anchor values would include a search for the child dimension values of “Personal Care” and “International” such as “Bath Soap,” “Beauty Soap,” “Canada,” and “Europe.” Based on Table 2, this insight search would result in the following relevant insights being recorded:

Entity Dimension Perspective with Product as Anchor Dimension:
[Personal Care, International]-> [Personal Care, Asia Pacific]
[Personal Care, Asia Pacific]-> [Personal Care, China]
[Bath Soap Brand 1, Asia Pacific]-> [Bath Soap Brand 1, China]
   Product Dimension Perspective with Entity as Anchor Dimension:
[International, Personal Care]-> [International, Baby Soap]
[Asia Pacific, Bath Soap]-> [Asia Pacific, Bath Soap Brand 1]

For each child insight detected of a parent-child insight pairing, a number of analytical values may be determined for the child insight. A contribution percentage may be determined for the child insight, representing the percentage of the parent insight that is caused by the contribution of the child insight. For a parent insight with only one child insight, the contribution of the child insight would be expected to be high, close to 100%. A historical average contribution percentage may be determined based on comparing a percentage contribution across a time domain for both the parent and child insights. An anomalous value or historical average value may be extracted from the child insight and stored or used for creating the insight summary. A percentage difference between the anomalous value of the child insight may be compared to a historical average value, for either the child insight or for the parent insight. A contribution percentage of a child insight may be compared to a historical average contribution percentage for the child insight across a time dimension.

### Prompt Generation

Relevant insights that have been stored for a given user query on certain dimensions are included in a prompt to a large language model to prompt the large language model to generate a summary of the various insights and their connections. In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein. The prompt may include a set of instructions for the large language model to define the desired output, set constraints on the generation of that output, data for including in the project summary, and descriptions of the data included.

In one example, a configuration command may be provided to a query processing service in a user session or connection with a client to select a particular large language model for use with the natural language of incoming queries on a user session, or for given requests, from the client. For example, the “OpenAI” large language model provider may be chosen with named credentials. The model used may be, for example, gpt-3.5-turbo. Other example providers include, but are not limited to, Cohere, Azure AI, Google PaLM 2, Llama 3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

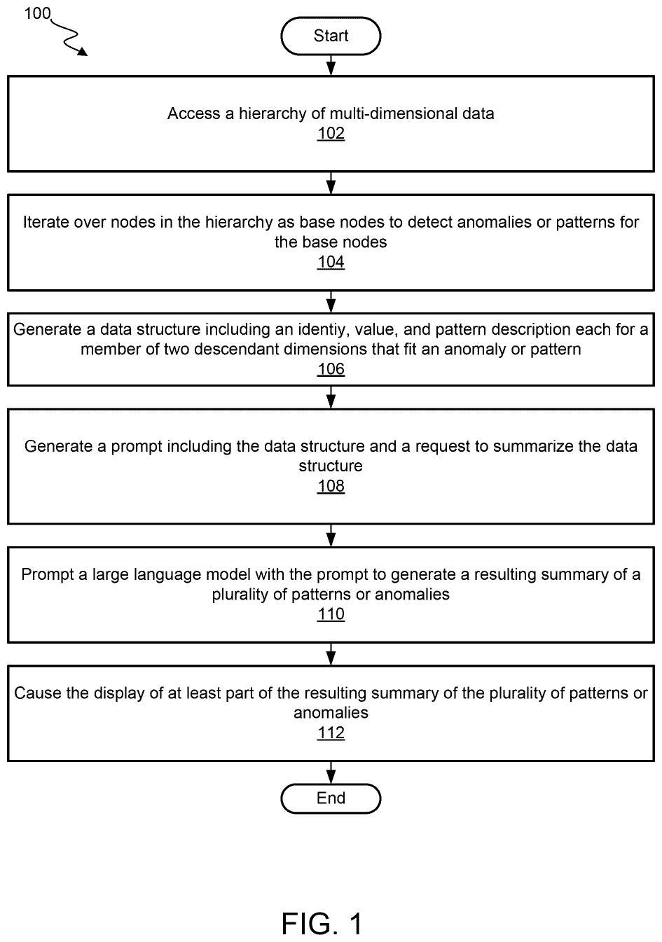

FIG. 1 depicts a flowchart 100 describing an example process for generating insight summaries by a data insight system. At block 102, a hierarchy of multi-dimensional data is accessed. The hierarchy includes one or more ancestor nodes and two or more descendant dimension nodes. At block 104, the data insight system iterates over nodes in the hierarchy as base nodes to detect anomalies or patterns for the base nodes. The iterating may include sub-steps of detecting a first anomaly or pattern for a first descendant dimension of a selected base node and detecting a second anomaly or pattern for a second descendant dimension of a selected base node. At block 106, a data structure is generated encapsulating a first identity of a member of the first descendant dimension that fits the first anomaly or pattern, one or more values of the first descendant dimension that fit the first anomaly or pattern, one or more characteristics of the first anomaly or pattern, a second identity of a member of the second descendant dimension that fits the second anomaly or pattern, one or more values of the second descendant dimension that fit the second anomaly or pattern, and one or more characteristics of the second anomaly or pattern. At block 108, a prompt is generated including the data structure and a request to summarize the data structure. At block 110, a large language model is prompted with the prompt to generate a resulting summary of a plurality of patterns or anomalies. At block 112, the data insight system causes the display of at least part of the resulting summary of the plurality of patterns or anomalies.

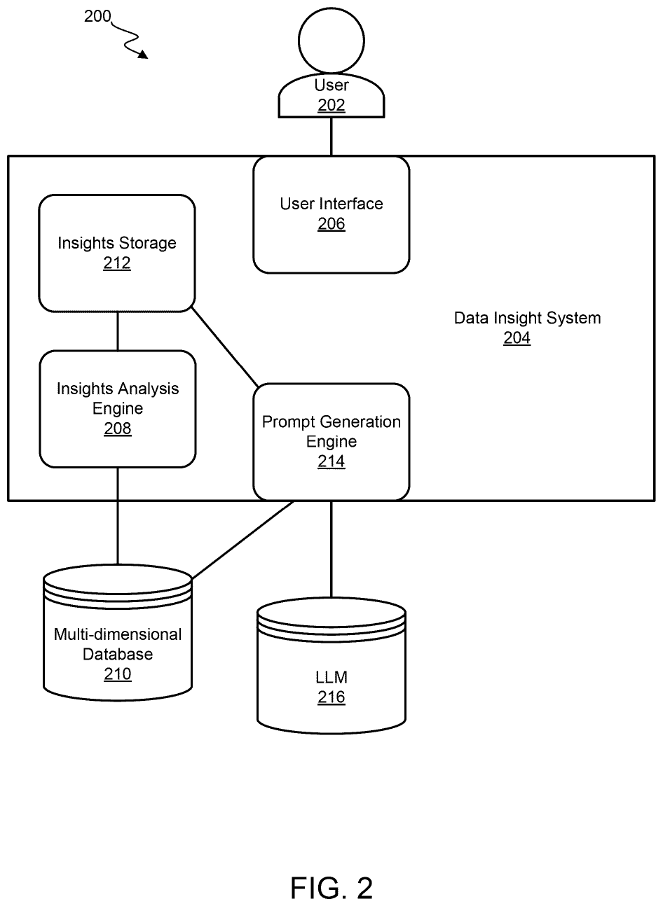

FIG. 2 depicts a distributed system 200 for generating insight summaries. A user 202 access a data insight system 204 via a user interface 206 and submits a user input indicating a request for generating an insight summary. The data insight system 204 contains an insight analysis engine 208, which performs various forms of analysis on a multi-dimensional database 210, the results of which are stored as insights in the insights storage 212. The user's input may indicate one or more insights via an indication of certain dimensions included in the data views for generated insights stored in the insights storage 212. The data insights system 204 extracts relevant insights from the insights storage 212 by iterating over the various dimensions of data based on the user input to determine if insights exist within insight storage 212 for the various dimensions. The insights found are passed to a prompt generation engine 214 along with data about the insights such as parentage information between insights. The prompt generation engine 214 generates a prompt which is prompted to a large language model 216 to cause it to generate and return a response insight summary which is displayed to the user 202 via the user interface 206.

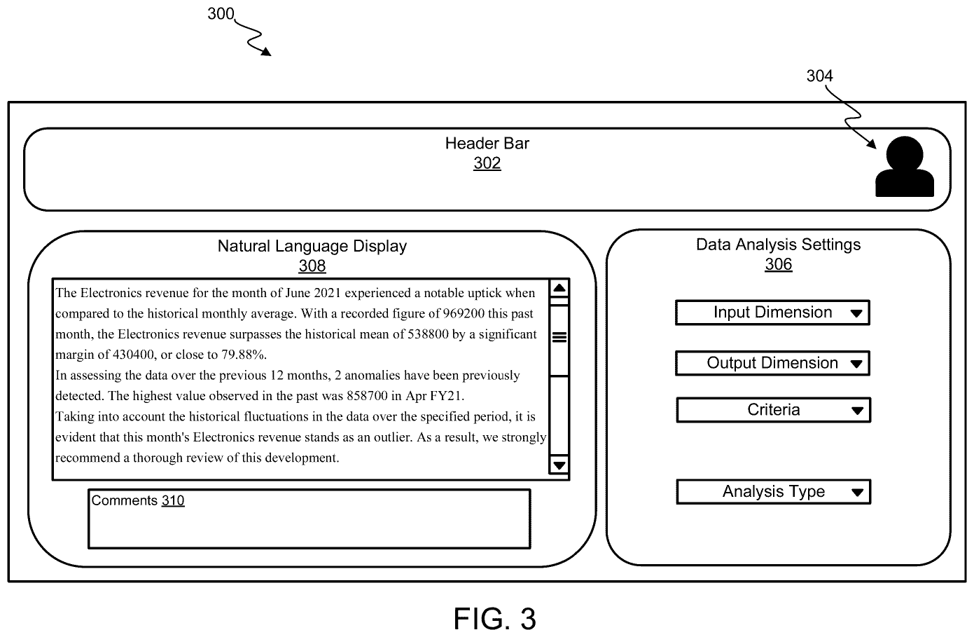

FIG. 3 depicts an example user interface 300 for requesting multi-dimensional analysis summaries. The example user interface may include a header bar 302 indicating a recognition of the user 304 via a set of user credentials. The set of user credentials may be used to confirm data access rights by the user. The user interface 300 also includes a set of data insight settings 306 for selection by the user to indicate a type of analysis for insights, desired dimensions for which relevant insights should be highlighted in the summary, or any other criteria of the insight summary. A data insight system interprets the user input in the data insight settings 306, performs any analysis, and generates a summary of the insights which is displayed in a natural language region 308. The user interface 300 also includes a comment region 310 for receiving user comments regarding the generated summary. Comments entered in the comment region may be used to control the data analysis, such as by submitting a query to the data insight system which may respond with a further generated summary derived from the same or a different insight.

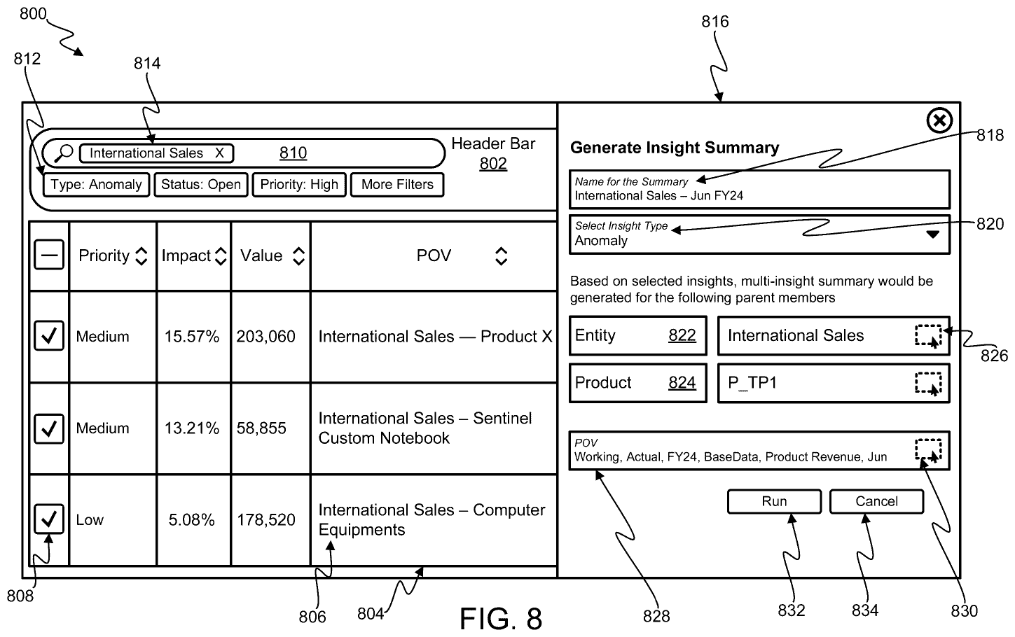

FIG. 8 depicts another user interface 800 for requesting summaries of multi-dimensional analyses. The user interface 800 includes an interface controls region 802 for controlling the currently displayed multi-dimensional analyses displayed within an analyses selection region 804. The analyses selection region 804 displays one or more previously generated multi-dimensional analyses 806. The one or more previously generated multi-dimensional analyses 806 may be selected for use in generating the summary by a user interaction with a selection element 808. The one or more previously generated analyses 806 displayed in the analyses selection region 804 may be controlled or filtered by selecting a filter selection element 810. A user may interact with the filter selection element 810 such as by entering a search term into a search bar or by selecting one or more predetermined filter options 812 to filter the one or more previously generated analyses by the presence of the search term or target of the predetermined filter option. The user interface 800 is displayed with an active filter selection 814 filtering the previously generated analyses 806 to only show analyses relevant to “International Sales” such as previously generated analyses 806 with Internation Sales in the point of view. The user interface 800 also includes a summary generation control region 816 for determining settings for generating the summary. The summary generation control region 816 contains options for setting a generated summary name 818 and an analysis type 820. The user may also select parent members 822-824 to use in generating the summary. The data fields selected for the parent members 822-824 may be selected from a data selection view 826. The summary generation control region 816 also includes a selection for a point of view 828 for the data to use in generating the summary, which may be selected by a data selection view 830, which may display a tabular view of the data for selecting the point of view. The user interface 800 includes a run option 832 to generate the summary with the currently displayed settings and a cancel option 834 to remove the currently displayed settings.

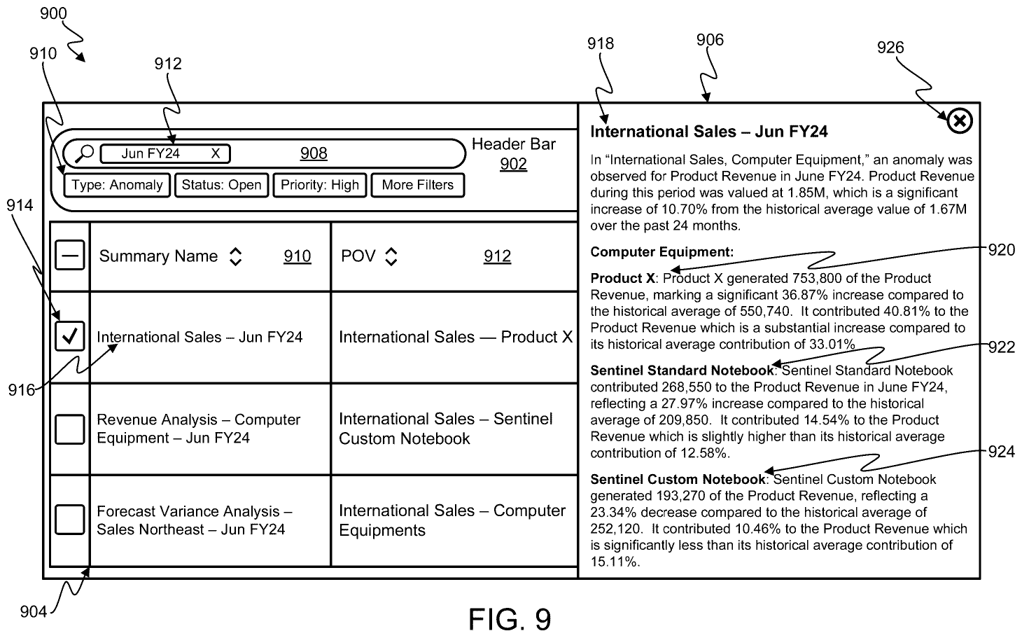

FIG. 9 depicts a user interface 900 for displaying generated summaries of multi-dimensional analyses. The user interface 900 contains a controls region 902, a summary selection region 904, and a summary display region 906. The controls region 902 contains one or more selections for controlling the currently displayed summaries in the summary selection region 904. The controls region 902 includes a filter selection element 908 for filtering the currently displayed summaries. A user may interact with the filter selection element 908 such as by entering a search term into a search bar or by selecting one or more predetermined filter options 910 to filter the displayed summaries by the presence of the search term or target of the predetermined filter option. The user interface 900 is displayed with an active filter selection 912 filtering the displayed summaries to only show summaries of the time period “June FY24.” The summary selection region 904 displays previously generated summaries of multi-dimensional analyses, filtered by settings of the control region 902, along with information about the summaries including a summary name 908 and a point of view used in generating the summary 910. One or more summaries displayed in the summaries selection region 904 may be selected by interaction with a selection element 914. The user interface 900 is displayed with a currently selected summary 916 selected via the selection element 914. The currently selected summary 916 may then be displayed in the summary display region 906. The summary display region 906 displays one or more currently selected summaries including a summary title 918. The displayed summary may contain information about a plurality of multi-dimensional analyses such as analyses for a plurality of products 920-924. The summary display region may include a deselection option 926 for dismissing the display of the currently selected summary 916.

The prompt may be generated automatically when populating a user interface detailing the data insights or it may be generated in response to a received input by a user. The prompt may be presented to the user for confirmation or editing before passing the prompt to the large language model.

The prompt may include a set of instructions for generating the insight summary. The instructions may direct the large language model as to the expected output, for example: “create an executive summary utilizing the data provided below.” The instructions may also indicate a context for the insight summary, such as an email format, press release, or website description. The context may include a prospective from which to write the response, such as an instruction indicating a position or persona to write the description from the perspective of.

The set of instructions in the prompt may further include constraints on the generation of the summary. For example, the prompt may include a word count constraint, a constraint on the type of language to use in the summary, or constrain the response to a number of paragraphs. The set of instructions may also include constraints to conform the output of the large language model to an expected format for parsing or interpreting after generation such as an instruction to remove any introductory phrase responsive specifically to the request of the prompt. The set of instructions may also include a requirement to include all data points provided within the prompt in the output summary.

The prompt may also include relevant parent and child insights with instructions as to the usage of data provided for the insights included. The instructions may include instructions on the usage of data provided and operations on the data to perform to translate the data provided to a summary format. For example, the instructions may direct the large language model to “Combine Parent and Metric name into an intuitive parent level name.”

The prompt may include data describing the parent insight, such as the anchor dimension value, the insight type, and the metric for the insight. The prompt may also include data of the parent insight, such as the time periods for the insight, the historical average value for the data described in the insight, the anomalous value of the insight, the percent difference between the anomalous value and the average value, or the direction of the insight.

Data provided in the prompt may be in a structured, plain text format such as JSON. The data may be structured in a nested formatting to indicate hierarchies within the data. The prompt may also include instructions for the large language model to return a summary in a structured, plain text format such as JSON for more easily parsing the summary or using the summary as data directly.

The prompt may also include data describing the child insights, such as the non-anchor aggregating dimension and the value for that dimension. The prompt may also include data of the child insight, such as the time periods for the insight, the historical average value for the data described in the insight, the anomalous value of the insight, the percent difference between the anomalous value and the average value, or the direction of the insight. The prompt may also include calculated values for the child insight relative to the parent insight such as the contribution percentage of the child insight, the historical average contribution percentage, and the contribution percentage vs the historical average contribution percentage change type.

Below, an example prompt and example response to the example prompt is shown.

Example Prompt
### References
Parent Insight: {parent insight)
Child Insights: {child insights)
### Role
You are an expert business analyst tasked with preparing an executive summary for CEOs
and CFOs. This summary will utilize the provided data, ensuring that each element is
directly reflective of the input data structure. Make sure to write the summary in third-
person point of view and INCLUDE ALL data points from the provided references.
### Instructions and Output Format
Output an RFC8259-compliant JSON object in the following format:
[
{
“Overall Insight”: “<Combine parent and metric name into an intuitive parent level name and
describe the insight type, insight period, and the absolute value observed. Then describe the
historical average value for the past historical period and discuss how much the current value
has deviated from it (using the percentage difference).
Use simple English and do not use the term parent level insight anywhere.>”,
“Significant Insights Observed at Dimension Level”: “<Total number of child insights>”,
“Sections and Insights”:
{“<Significant Pattern 1>”:|
{“<Group 1>”:
“<For each group, in the first sentence, describe the Anomalous Value observed during the
given Insight Period and the percentage increase or decrease compared to the Historical
Average Value. The historical average value must be included and appear towards the end of
the first sentence; otherwise, it will be catastrophic as this value is the crux of the summary.
In the second sentence, describe the group's contribution percentage to the parent (using the
created parent level name) or total, comparing it to the historical contribution percentage and
noting whether it has increased or decreased. The summary must consist of two sentences in
total. The format and language should be similar to the appropriate text in the examples
section.>”
}
}
}
]
### Examples:
Parent Insight: [{“Parent”: “Account”, “Metric”: “Revenue”, “Insight Type”: “anomaly”,
“Historical Periods”: “12 months”, “Insight Period”: “2019-12-01”, “Historical Average
Value”: “21.46 million”, “Anomalous Value”: “27.37 million”, “Percentage Difference
between Anomalous Value vs Historical Average Value”: “27.54%”, “Anomalous Value vs
Historical Average Value change type”: “increase”}]
Child Insights: [{“Number of insights observed at dimension level”: “3”, “Significant pattern
1”: (“Dimension”: “Product”, “Groups”: [(“Group”: “Personal Care Product”, “Anomalous
Value”: “4.62 million”, “Contribution percentage”: “16.88%”, “Historical average
contribution percentage”: “10.25%”, “Historical Average Value”: “2.2 million”, “Percentage
Difference between Anomalous Value vs Historical Average Value”: “110%”, “Anomalous
Value vs Historical Average Value change type”: “increase”, “Contribution percentage vs
Historical average contribution percentage change type”: “increase”)]}, “Significant pattern
2”: (“Dimension”: “Entity”, “Groups”:[(‘Group”: “International Entity”, “Anomalous Value”:
“8.15 million”, “Contribution percentage”: “29.76%”, “Historical average contribution
percentage”: “30.65%”, “Historical Average Value”: “6.58 million”, “Percentage Difference
between Anomalous Value vs Historical Average Value”: “23.8%”, “Anomalous Value vs
Historical Average Value change type”: “increase”, “Contribution percentage vs Historical
average contribution percentage change type”: “decrease”}, {“Group”: “US Entity”,
“Anomalous Value”: “5.34 million”, “Contribution percentage”:“19.49%”, “Historical
average contribution percentage”: “19.41%”, “Historical Average Value”: “4.17 million”,
“Percentage Difference between Anomalous Value vs Historical Average Value”: “28.08%”,
“Anomalous Value vs Historical Average Value change type”: “increase”, “Contribution
percentage vs Historical average contribution percentage change type”: “increase”)]))]
Summary:
[
{
“Overall Insight”: “In the Account Revenue, an anomaly was observed in December 2019.
The revenue during this period was valued at 27.37 million, which is a significant increase of
27.54% from the historical average revenue of 21.46 million over the past 12 months.”,
“Significant Insights Observed at Dimension Level”: “3”,
“Sections and Insights”:
{“Product”:
{“Personal Care Product”:
“The Personal Care Product segment generated 4.62 million of the Account Revenue in
December 2019, marking a significant 110% increase compared to the historical average of
2.20 million. It contributed 16.88% to the Account Revenue which is a substantial increase
compared to its historical average contribution of 10.25%.”
},
“Entity”:
(“International Entity”:
“The International Entity segment generated 8.15 million of the Account Revenue in
December 2019, reflecting a 23.8% increase compared to the historical average of 6.58
million. It contributed 29.76% to the Account Revenue which is slightly less than its
historical average contribution of 30.65%.”,
“US Entity”:
“The US Entity segment contributed 5.34 million to the Account Revenue in December
2019, reflecting a 28.08% increase compared to the historical average of 4.17 million. It
contributed 19.49% to the Account Revenue which is marginally higher than its historical
average contribution of 19.41%.”
}
}
}
]
Parent Insight: [{“Parent”: “Retail”, “Metric”: “Total Prepaid Expense Assets”, “Insight
Type”: “anomaly”, “Historical Periods”: “8 quarters”, “Insight Period”: “Q3 2022”,
“Historical Average Value”: “3 million”, “Anomalous Value”; “1.3 million”, “Percentage
Difference between Anomalous Value vs Historical Average Value”: “−57%”, “Anomalous
Value vs Historical Average Value change type”: “decrease”}]
Child Insights: [{“Number of insights observed at dimension level”: “2”, “Significant pattern
1”: (“Dimension”: “Product”, “Groups”: [(“Group”: “Ultra Notebook 15 in”, “Contribution
percentage”: “24%”, “Historical average contribution percentage”: “34%”, “Anomalous
Value”: “0.31 million”, “Percentage Difference between Anomalous Value vs Historical
Average Value”: “−69%”, “Historical Average Value”: “1.02 million”, “Anomalous Value vs
Historical Average Value change type”: “decrease”, “Contribution percentage vs Historical
average contribution percentage change type”: “decrease”}]}, “Significant pattern 2”:
{“Dimension”: “Market”, “Groups”: [{“Group”: “NA IT”, “Contribution percentage”: “17%”,
“Historical average contribution percentage”: “75%”, “Anomalous Value”: “0.22 million”,
“Percentage Difference between Anomalous Value vs Historical Average Value”: “−75%”,
“Historical Average Value”: “0.9 million”, “Anomalous Value vs Historical Average Value
change type”: “decrease”, “Contribution percentage vs Historical average contribution
percentage change type”: “decrease”}]}}]
Summary:
[
{
“Overall Insight”: “In the Retail Total Prepaid Expense Assets, an anomaly was observed in
Q3 2022. The assets during this period were valued at 1.3 million, which is a significant
decrease of 57% from the historical average value of 3 million over the past 8 quarters.”,
“Significant Insights Observed at Dimension Level”: “2”,
“Sections and Insights”:
{“Product”:
{“Ultra Notebook 15 in”:
“The Ultra Notebook 15 in segment generated 0.31 million of the Retail Total Prepaid
Expense Assets in Q3 2022, marking a significant 69% decrease compared to the historical
average value of 1.02 million. It contributed 24% to the Retail Total Prepaid Expense Assets
which is a substantial decrease compared to its historical average contribution of 34%.”
}
“Market”:
{“NA IT”:
“The NA IT segment contributed 0.22 million to the Total Prepaid Expense Assets in Q3
2022, reflecting a 75% decrease compared to the historical average value of 0.9 million. It
contributed 17% to the Retail Total Prepaid Expense Assets which is significantly less than
its historical average contribution of 75%.”
}
}
}
]
Example Response to Example Prompt
[
{
“Overall Insight”: “In the North America OFS Operating Expense, an anomaly was observed
in June 2021. The expense during this period amounted to 27,000, reflecting a significant
increase of 125% from the historical average of 12,000 over the past 12 months.”,
“Significant Insights Observed at Dimension Level”: “4”,
“Sections and Insights”; {
“Entity”: {
“California”: “California's OFS Operating Expense in June 2021 was an anomalous 4,050, an
increase of 141% compared to the historical average of 1,680. California's contribution to the
total North America OFS Operating Expense increased to 15%, a 1% increase from its
historical average contribution.”,
“Texas”: “Texas spent 3,240 on OFS Operating Expense in the same period, which is an
increase of 108% compared to the historical average. Its contribution to the total decreased
marginally, contributing 12% compared to the historical 13% average.”
}
“Market”: {
“ICP IT US”: “The ICP_IT US segment accounted for 16,200 of the North America OFS
Operating Expense in June 2021, marking a 145% increase compared to the historical
average of 6,600. Its contribution to the total expense increased to 60%, a 5%
improvement.”,
“ICP Operations UK”: “The ICP Operations UK segment's expense contribution amounted to
5,940 in June 2021, a 98% increase compared to its historical average. This segment's
historical average contribution was 25%, and it contributed 22% in the anomalous period.”
}
}
}
]

### Execution of Prompt and Display of Summary

After generation of the prompt, the prompt is used to prompt a large language model to generate the desired output insight summary. The prompt may be sent to the large language model in a new session with the large language model or in a persistent session for generating multiple insight summaries. The generated summary is received from the large language model in a plain text format, which may or may not require additional post-processing.

The received output summary may be automatically parsed and edited based on default rules. For example, a pre-determined rule may direct the data insights system to parse the output summary and remove pre-determined language, such as introductory language describing the summary generated. For example, the data insights system may compare the first sentence of the generated summary for text containing “the summary”, “this summary”, “the insight summary”, “this insight summary”, “the first section”, “the first paragraph”, “the second paragraph,” and remove those sentences so as to detect introductory language included by the large language model. Another default rule may automatically parse the output summary for numerical values and a preceding keyword to compare with the associated value in the project data.

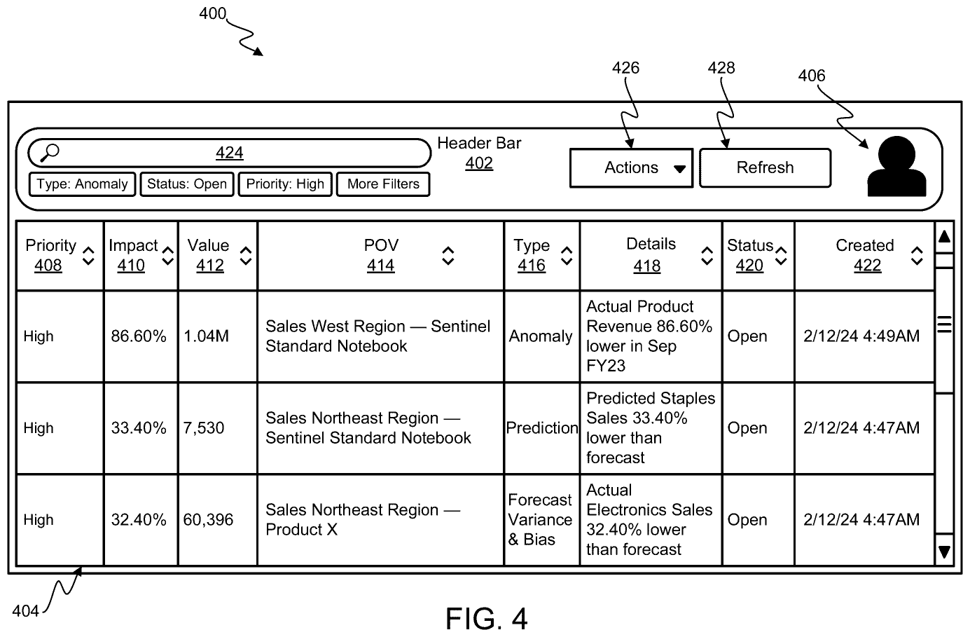

FIG. 4 depicts a user interface 400 for managing insights. The user interface may contain a plurality of regions 402-404 such as a header region 402 that contains controls for the user interface and a display region 404 for displaying information. The user interface 400 may detect a user 406 such as by a set of user credentials. The user interface 400 may determine by the user credentials various settings for the display of data such as whether display of certain data or data views is permitted. The display region 404 may display data 408-422 of generated summaries. The data comprises a priority 408 which may indicate a setting for the importance of the summary such as based on the relevance in time or a setting determined from the type of insight described. The data also comprises an impact 410 which may describe a value of the pattern or anomaly determined for the insight. The data also comprises a value 412 which may describe a value associated with the insight such as the value which is determined to be anomalous. The data also comprises a point of view 414 which may represent a data view used in determining the anomaly. The data also comprises a type 416 which describes the type of insight described such as an anomaly, a prediction, or a forecast variance bias. The data also comprises details 418 describing the insight detected. The data also comprises a status 420 which may describe the current state of the analysis or summary generation. The data also comprises a date 422 such as a date the summary was generated. The user interface 400 may also contain a set of navigation tools 424 such as a search or filtering function for controlling the data of summaries displayed. The navigation tools 424 may be used to filter the data such as by selecting insights within a certain dimension. The user interface 400 may also contain a selection for actions to perform with respect to the summaries such as selecting a publication or editing mode for interacting with the displayed summaries. The user interface 400 may also contain a refresh selection for updating the currently displayed summaries.

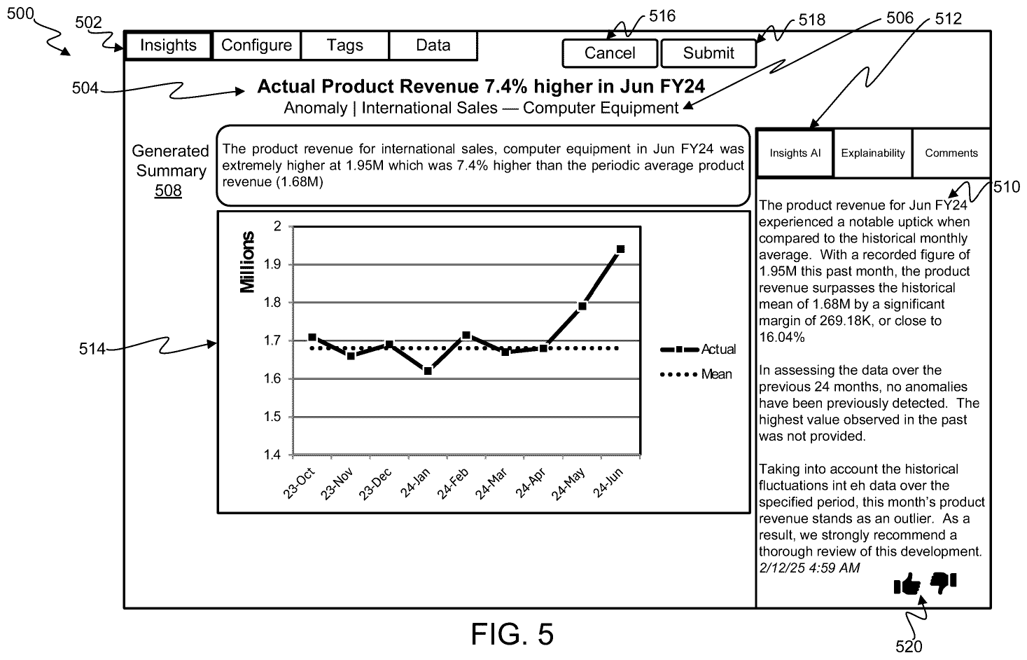

FIG. 5 depicts a user interface 500 for displaying a detailed view of an insight for which a summary was generated. The user interface 500 may contain a number of views 502 including a view for displaying a detailed view of an insight. The user interface 500 displays a current insight 504 including a metadata of the insight. The metadata of the includes data view 506 of the insight which includes the relevant dimensions included in the insight. In the example displayed in FIG. 5, the “Computer Electronics” data view may represent a plurality of dimensions that are beneath a parent dimension of “Computer Electronics.” The user interface 500 includes a generated summary 508 for the current insight 504. The user interface may display the generated summary 508 along with a further generated summary 510 which may be displayed via a further insights view 512. The further generated summary 510 may be a more detailed summary of the same current insight 504. The further generated summary 510 and the generated summary 508 may be generated separately or one may be derived from the other by re-prompting a large language model to generate an alternative summary. The user interface 500 may also display the generated summary 508 along with a data visualization 514 generated for the data. The data visualization 514 may be a graph or other visualization which may be predetermined for the type of insight of the current insight 504. The user interface 500 may contain a number of settings 516-518 for using the generated summaries. A cancel option 516 may permit the user to cancel editing the current insight 504 and undo any edits to the generated summary 504. A submit option 518 may cause the generated summary 508 to be submitted such as to a publication system, optionally with the currently displayed further generated summary 510 and/or the data visualization 514. The user interface 500 may also comprise a user feedback selection 520 for entering user feedback such as for the generated summary 508 or the further generated summary 510. Negative user feedback received may cause a new summary to be generated and displayed in the user interface 500.

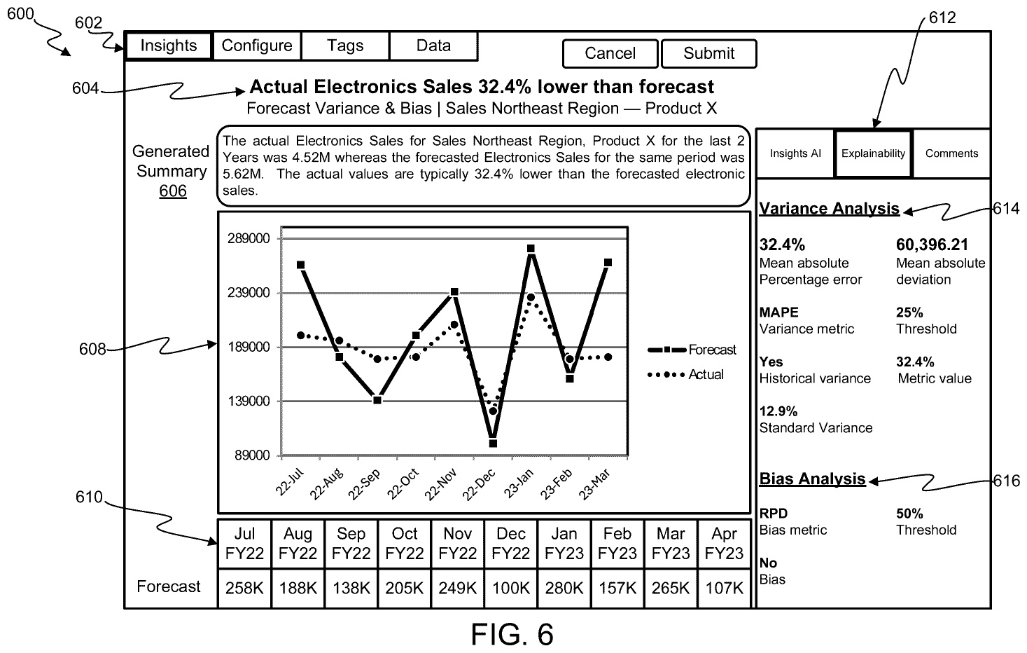

FIG. 6 depicts a user interface 600, which may be an alternate view of the same user interface as FIG. 5, for displaying a detailed view of an insight for which a summary was generated. The user interface 600 may contain a number of views 602 including a view for displaying a detailed view of an insight. The user interface 600 displays a current insight 604 including a metadata of the insight such as a title or data view. The user interface 600 includes a generated summary 606 for the current insight 604. The user interface may display the generated summary 606 along with a data visualization 608 generated for the data. The data visualization 608 may be a graph or other visualization which may be predetermined for the type of insight of the current insight 604. The generated summary 606 may also be displayed with a data table 610 displaying at least some of the data that the current insight 604 describes. The generated summary 606 may also be displayed with further details 612 of the insight including settings 614-616 used to detect the insight. The settings 614-616 may contain settings for one or more types of analysis such as settings for a variance analysis 614 including a calculated variance, and variance metric used, and settings for a bias analysis 616 including a determination of bias and a bias metric used.

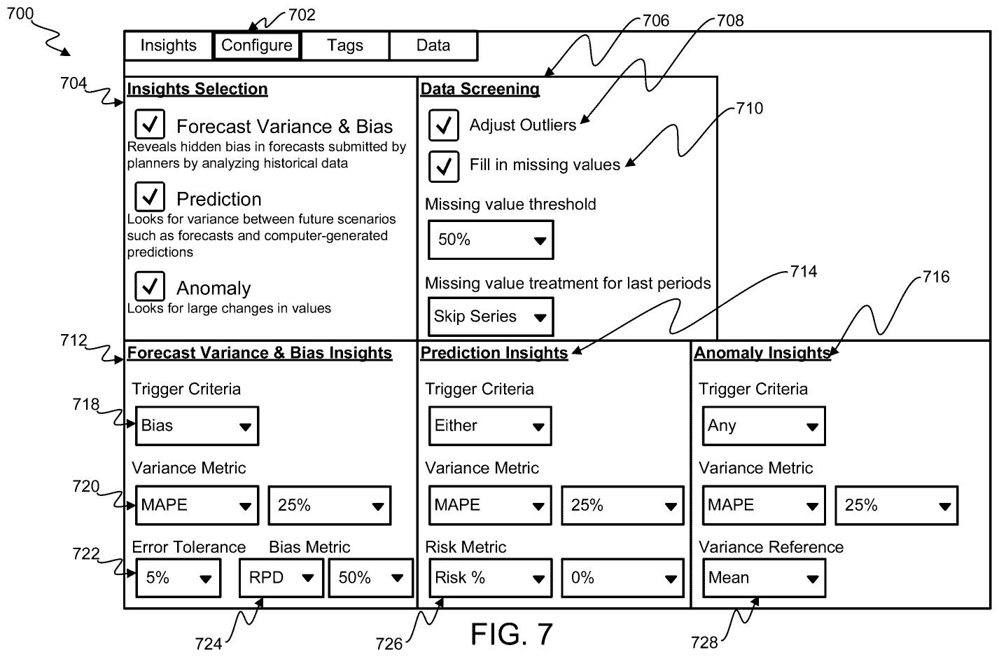

FIG. 7 depicts a user interface 700 displaying a configuration page 702 for displaying controls for determining insight detection. The configuration page 702 contains a selection for insights 704 for selecting what type of patterns or anomalies may currently be detected. The configuration page 702 also contains a set of data manipulation options 706 such as for determining a number of processes for pre-screening data prior to insight detection. The data manipulation options 706 may contain a setting for adjusting outliers 708 to toggle whether to alter values that do not fit the set of data for reasons other than the presence of an anomaly. The data manipulation options 706 may also contain a setting for addressing missing values 710 such as by filling in missing values with a value derived from surrounding values by a determined threshold or by skipping missing values. The configuration page 702 also contains a plurality of settings 712-716 specific to certain types of pattern or anomalies. The plurality of settings 712-716 may contain a trigger criteria setting 718 for determining what triggers are to be used for determining the existence of a pattern or analysis. The trigger criteria setting 718 may be one or more triggers. The plurality of settings 712-716 may contain a variance metric 720 including a metric to calculate and a threshold value to compare against for determining if the variance exists. The plurality of settings 712-716 may contain an error tolerance for setting a tolerance for an error of a single element of a time series. The plurality of settings 712-716 may contain a bias metric 724 comprising a metric and a threshold for determining a comparison between two values for the determination of a bias. The plurality of settings 712-716 may contain a risk metric 726 including a metric and a threshold for determining a variance of a forecasted value from a base prediction value. The plurality of settings 712-716 may contain a variance reference setting 728 for determining a value from which a variance is determined such as a previous value or a mean of a timeseries of values.

### Re-Prompting the Large Language Model

After receiving the output summary from the large language model, the output summary is displayed to the user. Within the display to the user, the output summary may be edited by the user to modify the output summary into a final project summary. Alternatively, the output summary may be modified by re-prompting the large language model to generate a second output summary with new criteria. In yet another alternative, the user interface may permit the entering of feedback from the user, which may be used in re-prompting the large language model.

When re-prompting the large language model, the previous prompt may be used in whole or in part to prompt the large language model to generate the second output summary. A second prompt may be used which may incorporate components of the previous prompt, such as the instructions or project data to include. The second prompt may also include the prior output summary with added instructions explaining the prior output summary to be a prior attempt to generate a summary by the large language model and any additional instructions of changes or differences to include in the second output summary. The second prompt may also include user feedback entered in response to the display of the prior output summary, which may indicate changes or differences to include in the second output summary.

Alternatively, when re-prompting the large language model, the second prompt may be sent to the large language model within the same session with the large language model as the previous prompt. In this case, the prompt may refer to the previous response and indicate changes or desired differences for a second output summary.

A user input indicating to re-prompt the large language model may be a selection from a pre-determined list of alterations to the output summary. For example, options may be displayed with the output summary to lengthen or shorten the output summary. In the case that a user selects an option to shorten or lengthen the output summary, a new prompt may be generated where the prompt is generated using a profile for generating shorter or longer prompts than a prior profile used to generate the first prompt.

After an output prompt is selected by the user and optionally undergone a post-processing step, the output summary may be stored and displayed to the user. The user interface for requesting a project summary may also include a publication method, such as sending the summary as a message or submitting the summary for display on a website.

### Multi-Dimensional Analysis by Artificial Intelligence Agents

Various elements of the present disclosure for multi-dimensional analysis may be performed by an artificial intelligence agent. One or more artificial intelligence agents may be tasked with generating one or more summaries of insights for multi-dimensional data. The artificial intelligence agents may be trained to perform specific tasks with regards to multi-dimensional analysis such as generating the prompt to a large language model or performing analysis on multi-dimensional data.

The one or more artificial intelligence agents may be specific to a certain type of data or use case. For example, an artificial intelligence agent may be trained only using multi-dimensional data representing sales data for one or more products, in which case the artificial intelligence agent may be specific to handling the generation of summaries of multi-dimensional data analysis relating to sales data such as sales forecasting or profit realization. In another example, an artificial intelligence agent may be specific to a certain role or task within the analysis of multi-dimensional data such as generating summaries or determining insights. The one or more artificial intelligence agents may be selected by first determining a type of data or use case of the set of multi-dimensional data. The determined type of data or use case may then be compared to a type of data or use case associated with each artificial intelligence agent of a plurality of pre-trained artificial intelligence agents.

In one embodiment, a managing agent determines one or more types of data being analyzed, and the managing agent assigns one or more worker agents specialized to handle each of the one or more types determined. The worker agents may analyze the data with the assistance of generative artificial intelligence, one or more customized prompt templates optionally specific to the corresponding worker agent, and/or one or more customized tools optionally specific to the corresponding worker agent. The managing agent may then assemble results from the one or more worker agents to provide a cohesive analysis of the multidimensional data.

The one or more artificial intelligence agents may perform additional tasks prior to or after prompting a large language model for generating summaries of multi-dimensional data analysis relevant to the type of data or use case associated with the data. For example, an artificial intelligence agent used for multi-dimensional data analysis of data involving personally identifiable information may perform an extra step prior to generating a prompt of removing or masking certain personally identifiable information from the data such that the personally identifiable information is not exposed to the large language model. In another example, the same artificial intelligence agent may, after generating a prompt and prompting a large language model to generate a summary, perform an extra step of analyzing the generated summary and editing the summary or re-prompting the large language model to generate a new summary when aspects of the summary indicate a bias. The additional tasks may be facilitated by a set of tools accessible by the one or more artificial intelligence agents such as access to submit API calls, other machine learning models, templates, or access to further artificial intelligence agents.

In one example, the one or more artificial intelligence agents includes a managing artificial intelligence agent, which instantiates each of the one or more artificial intelligence agents used in generating summaries of multi-dimensional analysis. The managing artificial intelligence agent may determine a number of other artificial intelligence agents necessary to generate summaries of multi-dimensional analysis for the set of multi-dimensional data, such as by parsing the dimensions of the multi-dimensional data to determine a type of data or use case of the multi-dimensional data. The managing artificial intelligence agent may determine, such as by parsing the dimensions of the multi-dimensional data, a number of analyses to perform and generate summaries of. The managing artificial intelligence agent may instantiate a number of artificial intelligence agents to each perform one of the number of analyses to perform for the multi-dimensional data. For example, a managing artificial intelligence agent may determine a set of multi-dimensional data contains data for sales of a first period, data for projected sales for the first period, and data for sales of a second period. The managing artificial intelligence agent may determine a first analysis to perform between the data for sales of the first period and data for projected sales for the first period and instantiate a first artificial intelligence agent for performing the first analysis and generating a first partial summary. The managing artificial intelligence agent may also determine a second analysis to perform between the data for sales of the first period and data for sales of the second period and instantiate a second artificial intelligence agent for performing the second analysis and generating a second partial summary. The managing artificial intelligence agent may receive the first and second partial summaries from the first and second artificial intelligence agents and may generate a cohesive summary based on the first and second partial summaries.

In another embodiment a managing agent may be tasked with performing a search loop across a number of data views based on a certain anchor dimension. The managing agent may determine, within the search loop, a number of data views for which there is a relevant insight. The managing agent may instantiate, for each relevant insight, a worker agent in order to handle the generation of a summary or partial summary of that relevant insight. In one embodiment, a managing agent may perform a search loop over a set of parent dimensions and, for each parent dimension where a relevant insight is detected, the managing agent may instantiate a sub-managing agent for searching across child dimensions of the parent agent. When analyzing a parent dimension, the managing agent may detect that the dimension is a parent dimension to a descendant dimension and, in response, instantiate a second artificial intelligence agent as a worker agent to iterate over the child nodes of the descendant dimension, where the second artificial intelligence agent is a different artificial intelligence agent from the managing agent.

In yet another embodiment, a managing agent may first determine a number of anchor dimensions based on determinations of the aggregating ability of each dimension. The managing agent may then instantiate a number of sub-managing agents which may perform a search loop to determine relevant data views including their respective anchor dimensions.

Alternatively, an artificial intelligence agent may be tasked with determining when an insight exists and initiates the generation of a prompt to generate a summary of the insight in response to detecting the insight. For example, an artificial intelligence agent may be tasked with determining when a type of anomaly exists within a set of multi-dimensional data. The artificial intelligence agent may perform a data analysis on the data in response to receiving an update to the set of multi-dimensional data. In another example, an artificial intelligence agent may be tasked with reviewing predictions for errors and generating a prompt to generate a summary for the prediction variance when it is detected.

The one or more artificial intelligence agents may communicate between each other by sharing data, derived analyses, or generated summaries. For example, a first artificial intelligence agent may be tasked with performing data analysis, the results of which the first artificial intelligence agent gives to a second artificial intelligence agent for generating a summary of. The first artificial intelligence agent may also be tasked with iterating over nodes in a hierarchy as base nodes to detect anomalies or patterns for the base nodes and an anomaly or pattern that is detected by the first artificial intelligence agent may be used by the second artificial intelligence agent to generate a prompt to a large language model comprising a data structure comprising information about the anomaly or pattern, in order to generate a summary of the anomaly or pattern. Artificial intelligence agents may share data of patterns or anomalies for the purposes of determining underlying information about the insight. For example, in the case that multiple anomalies are detected for a set of multi-dimensional data by a plurality of artificial intelligence agents, the plurality of artificial intelligence agents may communicate their respective determined anomalies in order to determine an underlying cause for the multiple anomalies.

### Computer System Architecture

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for analyzing multi-dimensional data.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for analyzing multi-dimensional data in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIXX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 814 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for analyzing multi-dimensional data. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

FIG. 9 is a simplified block diagram of a cloud-based system environment in which analyzing multi-dimensional data summaries, in accordance with certain aspects. may be performed. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise a service management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the service provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

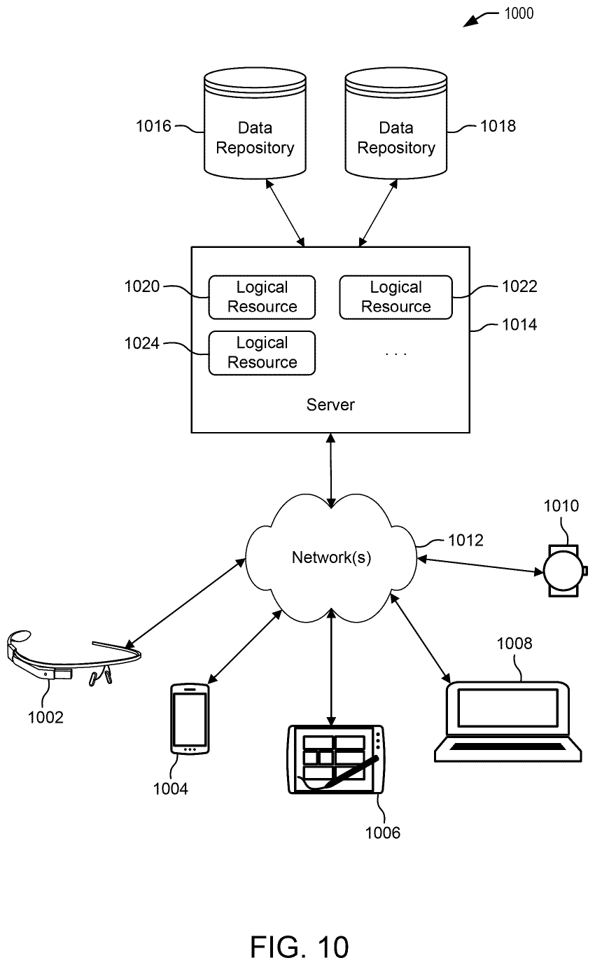

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory and/or transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a hierarchy of a multi-dimensional data, wherein the hierarchy comprises one or more ancestor nodes and two or more descendant dimension nodes;
iterating over nodes in the hierarchy as base nodes to detect anomalies or patterns for the base nodes, wherein the iterating comprises:
detecting a first anomaly or pattern for a first descendant dimension of a selected base node; and
detecting a second anomaly or pattern for a second descendant dimension of the selected base node;
generating a data structure that encapsulates:
a first identity of a member of the first descendant dimension that fits the first anomaly or pattern,
one or more values of the first descendant dimension that fit the first anomaly or pattern,
one or more characteristics of the first anomaly or pattern,
a second identity of a member of the second descendant dimension that fits the second anomaly or pattern,
one or more values of the second descendant dimension that fit the second anomaly or pattern, and
one or more characteristics of the second anomaly or pattern;
generating a prompt comprising the data structure and a request to summarize the data structure;
prompting a large language model with the prompt to generate a resulting summary of a plurality of patterns or anomalies; and
causing display of at least part of the resulting summary of the plurality of patterns or anomalies.

2. The computer-implemented method of claim 1, wherein the second descendant dimension is also a descendant of the first descendant dimension.

3. The computer-implemented method of claim 2, wherein the prompt further comprises data representing a relationship between the first anomaly or pattern and the second anomaly or pattern.

4. The computer-implemented method of claim 3, wherein the data representing a relationship between the first anomaly or pattern and the second anomaly or pattern is a representation of the contribution of the second anomaly or pattern to the first anomaly or pattern.

5. The computer-implemented method of claim 1, wherein the iterating further comprises:
detecting the first descendant dimension to be a parent dimension to the second descendant dimension; and
iterating over child nodes of the first descendant dimension, and wherein the detecting the second anomaly or pattern is in response to iterating over child nodes of the first descendant dimension.

6. The computer-implemented method of claim 5, wherein the detecting the first descendant dimension to be a parent dimension is performed by a first artificial intelligence agent and wherein the iterating over child nodes of the first descendant dimension is performed by a second artificial intelligence agent.

7. The computer-implemented method of claim 1, wherein the iterating is performed by a first artificial intelligence agent and wherein the generating a prompt is performed by a second artificial intelligence agent.

8. A computer-program product comprising one or more non-transitory machine-readable storage media, including stored instructions configured to cause a computing system to perform a set of actions including:
accessing a hierarchy of a multi-dimensional data, wherein the hierarchy comprises one or more ancestor nodes and two or more descendant dimension nodes;
iterating over nodes in the hierarchy as base nodes to detect anomalies or patterns for the base nodes, wherein the iterating comprises:
detecting a first anomaly or pattern for a first descendant dimension of a selected base node; and
detecting a second anomaly or pattern for a second descendant dimension of the selected base node;
generating a data structure that encapsulates:
a first identity of a member of the first descendant dimension that fits the first anomaly or pattern,
one or more values of the first descendant dimension that fit the first anomaly or pattern,
one or more characteristics of the first anomaly or pattern,
a second identity of a member of the second descendant dimension that fits the second anomaly or pattern,
one or more values of the second descendant dimension that fit the second anomaly or pattern, and
one or more characteristics of the second anomaly or pattern;
generating a prompt comprising the data structure and a request to summarize the data structure;
prompting a large language model with the prompt to generate a resulting summary of a plurality of patterns or anomalies; and
causing display of at least part of the resulting summary of the plurality of patterns or anomalies.

9. The computer-program product of claim 8, wherein the second descendant dimension is also a descendant of the first descendant dimension.

10. The computer-program product of claim 9, wherein the prompt further comprises data representing a relationship between the first anomaly or pattern and the second anomaly or pattern.

11. The computer-program product of claim 10, wherein the data representing a relationship between the first anomaly or pattern and the second anomaly or pattern is a representation of the contribution of the second anomaly or pattern to the first anomaly or pattern.

12. The computer-program product of claim 8, wherein the iterating further comprises:
detecting the first descendant dimension to be a parent dimension to the second descendant dimension; and
iterating over child nodes of the first descendant dimension, and wherein the detecting the second anomaly or pattern is in response to iterating over child nodes of the first descendant dimension.

13. The computer-program product of claim 12, wherein the detecting the first descendant dimension to be a parent dimension is performed by a first artificial intelligence agent and wherein the iterating over child nodes of the first descendant dimension is performed by a second artificial intelligence agent.

14. The computer-program product of claim 8, wherein the iterating is performed by a first artificial intelligence agent and wherein the generating a prompt is performed by a second artificial intelligence agent.

15. A system comprising:
one or more processors;
one or more non-transitory computer-readable media storing instructions, which, when executed by the system, cause the system to perform a set of actions including:
accessing a hierarchy of a multi-dimensional data, wherein the hierarchy comprises one or more ancestor nodes and two or more descendant dimension nodes;
iterating over nodes in the hierarchy as base nodes to detect anomalies or patterns for the base nodes, wherein the iterating comprises:
detecting a first anomaly or pattern for a first descendant dimension of a selected base node; and
detecting a second anomaly or pattern for a second descendant dimension of the selected base node;
generating a data structure that encapsulates:
a first identity of a member of the first descendant dimension that fits the first anomaly or pattern,
one or more values of the first descendant dimension that fit the first anomaly or pattern,
one or more characteristics of the first anomaly or pattern,
a second identity of a member of the second descendant dimension that fits the second anomaly or pattern,
one or more values of the second descendant dimension that fit the second anomaly or pattern, and
one or more characteristics of the second anomaly or pattern;
generating a prompt comprising the data structure and a request to summarize the data structure;
prompting a large language model with the prompt to generate a resulting summary of a plurality of patterns or anomalies; and
causing display of at least part of the resulting summary of the plurality of patterns or anomalies.

16. The system of claim 15, wherein the second descendant dimension is also a descendant of the first descendant dimension.

17. The system of claim 16, wherein the prompt further comprises data representing a relationship between the first anomaly or pattern and the second anomaly or pattern.

18. The system of claim 17, wherein the data representing a relationship between the first anomaly or pattern and the second anomaly or pattern is a representation of the contribution of the second anomaly or pattern to the first anomaly or pattern.

19. The system of claim 15, wherein the iterating further comprises:
detecting the first descendant dimension to be a parent dimension to the second descendant dimension; and
iterating over child nodes of the first descendant dimension, and wherein the detecting the second anomaly or pattern is in response to iterating over child nodes of the first descendant dimension.

20. The system of claim 19, wherein the detecting the first descendant dimension to be a parent dimension is performed by a first artificial intelligence agent and wherein the iterating over child nodes of the first descendant dimension is performed by a second artificial intelligence agent.
